(19) United States
(12) Patent Application Publication
(10) Pub. No.: US 2014/0304976 A1
(43) Pub. Date: Oct. 16, 2014

(54) System and Method for Retrofitting Existing Manual Price Signs

(71) Applicant: Max F. Krawinkel, Koln (DE)

(72) Inventor: Max F. Krawinkel, Koln (DE)

(21) Appl. No.: 13/949,745

(22) Filed: Jul. 24, 2013

Related U.S. Application Data
(60) Provisional application No. 61/834,779, filed on Jun. 13, 2013.

(51) Int. Cl. G09F 13/22

(52) U.S. Cl. CPC G09F 13/22
USPC 29/592.1

(57) ABSTRACT

A system and method for retrofitting manual price signs at or for highway service stations like gas stations. The present invention includes electronic LED price digits that can be replacement-inserted into slots in existing signs. In a first embodiment, digits are installed on existing sign rails after removing manual digits. In a second embodiment, digits can be installed directly inside the sign.

This application is related to, and claims priority from, U.S. Provisional Patent Application No. 61/834,779 filed Jun. 13, 2013. Application 61/834,779 is hereby incorporated by reference in its entirety.

### BACKGROUND

1. Field of the Invention

The present invention relates generally to price display signs at roadside service stations such as gasoline stations and more particularly to a system and method for retrofitting existing manual signs with separate electronic LED digits.

2. Description of the Prior Art

Lighted price signs at gasoline service stations are well-known in the art. Many such service stations also have signs that were made to hold manual digits. When a price changes, each changed digit must be removed by hand and a new digit inserted. Many service stations are still equipped with these types of manual signs. It would be advantageous to have a system and method for retrofitting these signs with electronic digits without changing out the entire sign or installing pre-assembled single-sided price sign boxes in front of the face with the impact of an image change.

### SUMMARY OF THE INVENTION

The present invention relates to a system and method for retrofitting manual price signs at highway service stations like gas stations. The present invention includes electronic LED price digits that can be replacement-inserted into slots in existing signs.

Part of the present invention is innovative design of the digits: They are front mounted SMD digits, encapsulated with a rubber-like chemical. The effect is that the digit itself is IP67 compliant, which means totally water proved. This allows them to be installed in a rail of the static tiles, and be exposed to water. In addition, the innovative design reduces the thickness of each single digit. Conventional digits are built with through-hole LED's and their typical thickness is about 15 mm (around 9/16″). The SMD digits come with a thickness of 5 mm (around 3/16″) and with the front mounted face. The per digit total thickness is 9 mm (around ⅜″). Through this innovative design, these digits are able to fit into the rail of the static signs.

In a first embodiment, digits are installed on existing sign rails after removing manual digits. In a second embodiment, digits can be installed directly inside the sign.

### DESCRIPTION OF THE FIGURES

Several drawings and illustrations are presented to aid in understanding the features of the present invention:

FIG. 1 shows retrofitting an existing manual sign.

FIG. 2 shows a finished retrofitted sign.

FIG. 3 shows an inserted electronic digit according to the present invention with cable holes for other digits.

FIGS. 4A-4B show a front and side view respectively of an electronic digit according to the present invention.

FIGS. 5A-5B show an option with black backgrounds with black inserts between digits.

FIGS. 6A-6B show an option with black backgrounds and no inserts on the gasoline price digits.

FIGS. 7A-7B show an option with no backgrounds and no inserts.

FIG. 8 shows an isolated electronic digit according to the present invention.

FIG. 9 shows encapsulated digits according to the second embodiment of the present invention.

The scope of the present invention is not limited to what is shown in the figures.

### DESCRIPTION OF THE INVENTION

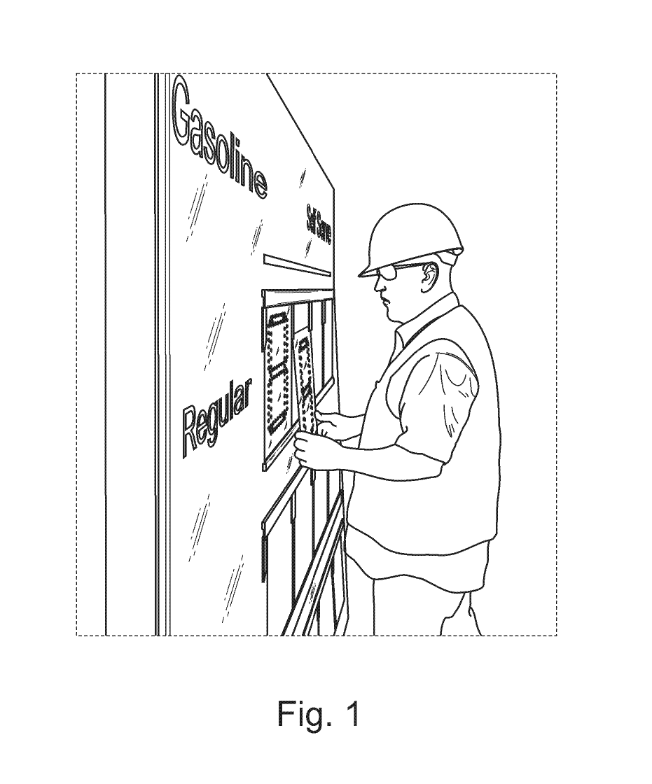

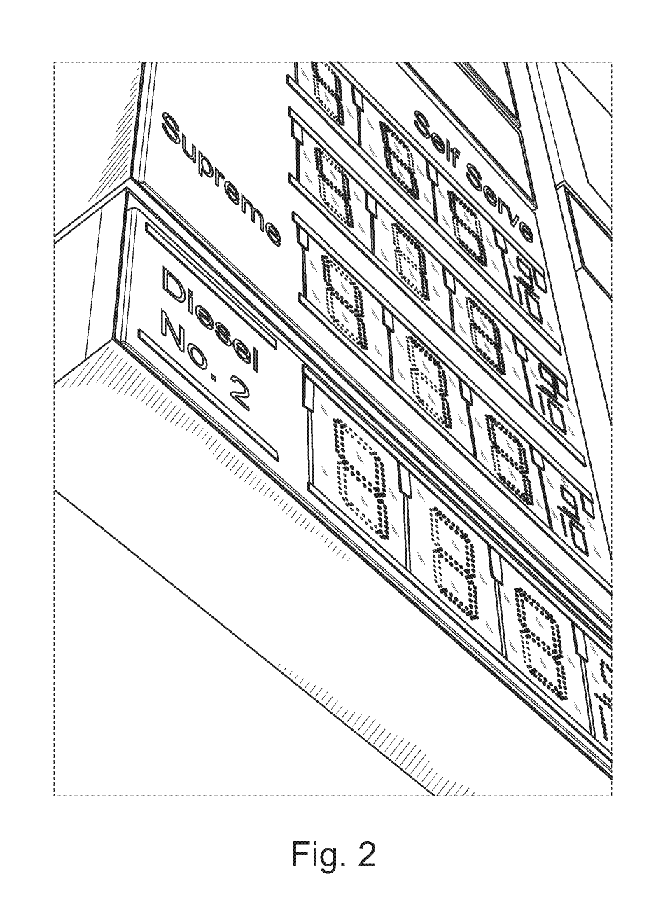

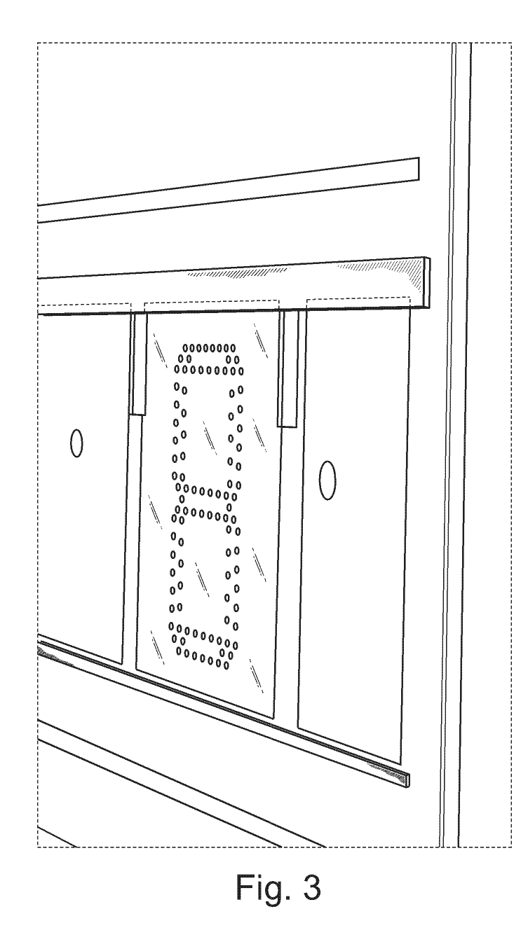

The present invention relates to a system and method for retrofitting manual price signs at highway service stations like gas stations. The present invention includes electronic LED price digits that can be replacement-inserted into slots in existing signs. FIG. 1 shows workers inserting electronic digits according to the present invention into an existing manual sign. FIG. 2 shows the finished sign. FIG. 3 shows an inserted electronic digit.

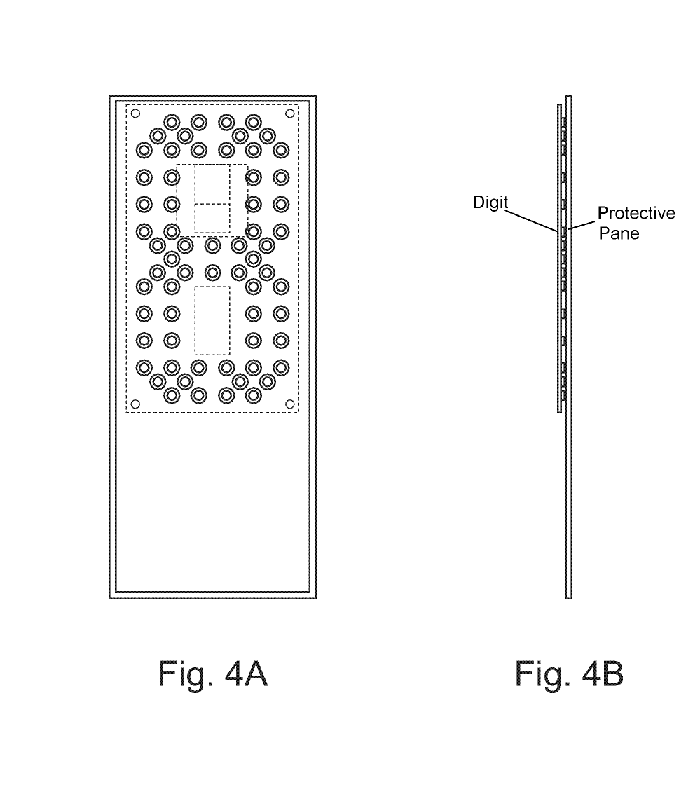

The electronic digits of the present invention can be made by taking a printed or silk-screened plastic face, preferably polycarbonate, with a pattern of exact holes aligned for light output from surface-mounted LEDs on a printed circuit board as shown in FIGS. 4A-4B. The plastic face is connected to the printed circuit board so that the holes align with the LEDs on the board forming a sandwich-like structure (See FIG. 4B). The two pieces can be taped together, glued, bonded or connected together by any other method. The front side can be printed according to a particular customer or oil company's image and/or colors.

In a first embodiment, each digit or e-tile slides into the existing rails of the manual sign. Holes are made behind each tile for cables as part of the installation process before the tile is slid in. A single light sensor can be placed in a separate hole on the side of the sign that normally faces the sun so that overall LED brightness can be controlled. Signs must typically be brighter in bright sunshine to be seen, while they can be dimmed at night. Brightness can be computed according to an algorithm based on the amount of light received by the sensor. In some embodiments, the brightness can be different on different sides of the sign.

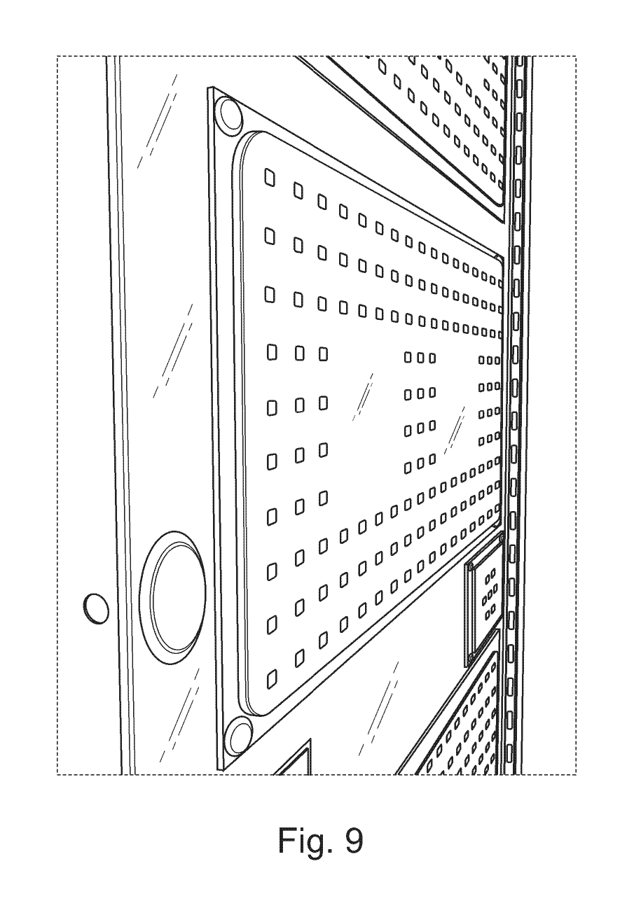

In a second embodiment, digits are installed inside the sign rather than on the existing rails. The advantage to this embodiment is that installation time is reduced because new faces can be pre-assembled in the shop and then delivered to a gas station for change out. This embodiment is also innovative since each digit is so slim, it can be installed directly behind the face and be mounted directly to the face. Prior art, pre-assembled insert boxes need to be installed inside the cabinet and mounted to the internal structure of a sign. Also the design feature of the present invention of just having holes for each SMD (light output) limits “black space”. A digit of the second embodiment is shown in FIG. 9.

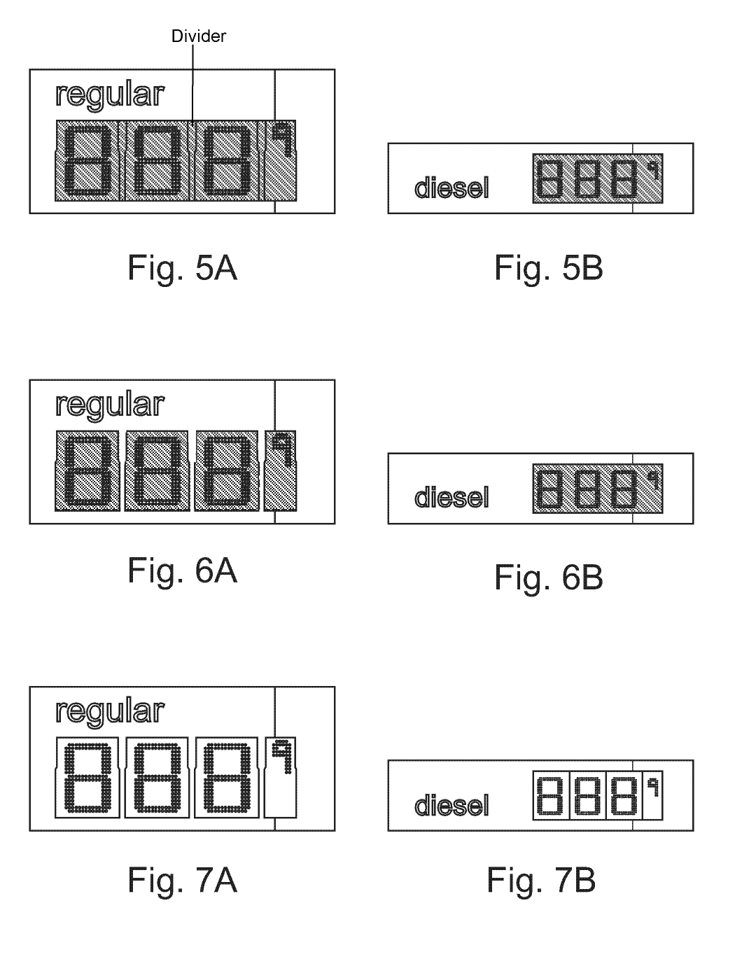

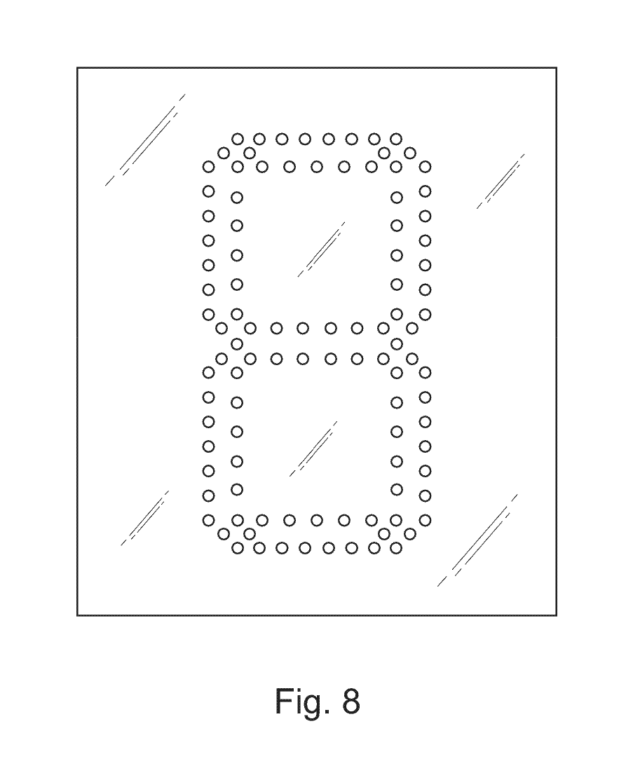

Digits can be presented in several different styles or options as shown in FIGS. 5A-5B, 6A-6B and 7A-7B. FIGS. 5A-5B show an option with black backgrounds with black inserts between digits. FIGS. 6A-6B show an option with black backgrounds and no inserts on the gasoline price digits. FIGS. 7A-7B show an option with no backgrounds and no inserts. FIG. 9 shows several encapsulated digits.

Each digit can be cabled through the hole to a digit controller inside the sign or at a remote location. The sensor can also feed the controller so that brightness can be controlled. Prices can be sent to the controller from units inside the station or from remote locations.

The installation procedure is roughly as follows:

1) removing all manual static price digits from said sign;

2) cutting a cable hole in each price digit position on said sign;

3) installing an LED electronic price digit in each digit position;

4) combining all cables from said LED electronic price digits into a line controller; (each single-sided line typically needs one line controller; then the line controllers are typically connected to one sign controller).

6) installing an ambient light sensor on an outer surface of the sign and cabling the light sensor to the sign controller;

As previously described, the controller can adjust the brightness of the electronic price digits based on the ambient light conditions. Generally, digits need to be brighter in direct sunlight than at night in order to be visible. In some cases, digits on different sides of the sign can be adjusted to a different brightness.

The controller sets the price shown on each digit, and can be driven from a remote location such as inside the station or over a network from a remote location. In some embodiments of the present invention, there is no controller in the actual sign, but rather, the controller can be located in the station or elsewhere. In some embodiments, the controller can communicate back the actual price being displayed. This can be displayed inside the station and even relayed to a remote location.

Each of the LED electronic price digits can be made up from a printed circuit board containing an array of LEDs in a digit configuration and a plastic cover with a plurality of holes corresponding to said array of LEDs as previously described. The front side of the plastic cover can be printed up or colored according to a petroleum supplier's specifications. In some embodiments, there is simply a plastic or other transparent cover.

The advantages of the present invention are many.
1. The present invention includes a “tile” system to retrofit existing manual signs to electronic signs.
2. The tile is only a digit with a face in the front; there is no need of a metal housing.
3. Competitors typically provide an entire single-sided block of red LED digits with a black background, and greater thickness.
4. The present invention is superior because:

a. The look is close to the existing image: white numerals with customer specified colors.

b. The invention is a modular system that results in higher flexibility.

c. The invention is a more environmentally friendly solution since less components are used, and there is a very limited waste of existing components. For example the present invention allows an almost complete re-usage of the existing sign with the exception of the manual tiles.

d. The invention achieves higher reliability because digits are more natural ventilated than in a closed box and epoxy housing of other LED systems that exist that are directly exposed to extreme weather conditions. The surface mount devices of the present invention are protected due to the face in front of each digit and the rubber-like encapsulated system.

e. The invention allows direct accessibility of the digits since they operate the same way as manual tile digits. No screws are necessary to unfasten the digits.

f. The entire system enjoys improved heat management since digits are not installed in a metal housing. Other benefits include:
1. No lose of permits, since the sign does not touch the ground: In many areas, once a sign is taken down, a new permit is required.
2. This solution is much more efficient because time to install the present invention is around half that of the current systems in the market.

Several descriptions and illustrations have been provided that aid in understanding the present invention. One with skill in the art will realize that numerous changes and variations may be made without departing from the spirit of the invention. Each of these changes and variations are within the scope of the present invention.

1. A method for fitting a price sign with LED digits comprising:
cutting a cable hole in each price digit position on said sign;
installing an LED electronic price digit in each digit position;
attaching cables from said LED electronic price digits to a controller;
installing an ambient light sensor on an outer surface of said sign and cabling said light sensor to said sign controller;
wherein each of said LED electronic price digits comprises a printed circuit board containing an array of LEDs in a digit configuration and a plastic cover over said LEDs, and wherein said LEDs do not protrude beyond an outer surface of said sign when installed.

2. The method of claim 1 wherein each of said plastic covers is colored or printed according to a particular petroleum supplier's specification.

3. The method of claim 1 wherein each digit is mounted on an existing manual digit rail.

4. The method of claim 1 wherein said electronic price digits are pre-assembled into a sign face before installation.

5. The method of claim 1 wherein said controller adjusts brightness of said electronic price digits based on an electrical signal from said ambient light sensor.

6. The method of claim 5 wherein electronic price digits on different sides of the price sign are adjusted so the each side of the sign has a different brightness.

7. The method of claim 1 wherein said plastic cover includes a plurality of holes corresponding to said array of LEDs.

8-17. (canceled)

18. A price sign comprising:
a plurality of price digits, each digit including:
a) a faceplate having a plurality of holes configured to form a pattern of an approximate figure-eight, said faceplate having an outer surface colored to correspond to a particular vendor's branding;
b) a circuit board mounted behind said faceplate containing a plurality of LEDs, wherein each LED is located behind one of said holes in the faceplate, and wherein the faceplate and circuit board from a sandwich-like structure;
and wherein each of said price digits can display all numerical digits from zero to nine by lighting different of said LEDs.

19. The price sign of claim 18 wherein said faceplate is plastic.

20. The price sign of claim 18 wherein said LEDs are surface-mounted on the circuit board.

21. The price sign of claim 18 wherein the faceplate and the circuit board are glued together.

22. A price sign having at least one LED price digit, the price digit comprising a faceplate and a circuit board attached together in a sandwich-like structure, the circuit board including a plurality of surface-mount LEDs in a digit configuration, and the faceplate having a plurality of holes, each hole aligned with an LED on the circuit board, wherein the faceplate is colored to conform with a particular vendor's branding.

23. The price sign of claim 22 having a plurality of said LED price digits configured to display a price for a product.

24. The price sign of claim 22 wherein said faceplate is plastic.

25. The price sign of claim 22 wherein said LEDs are surface-mounted on the circuit board.

26. The price sign of claim 22 wherein the faceplate and the circuit board are glued together.
